(19) United States
(12) Patent Application Publication
(10) Pub. No.: US 2012/0279365 A1
(43) Pub. Date: Nov. 8, 2012

(54) Bolt-Through Torque Wrench Assembly

(75) Inventors: David Cummings, Princeton, MA (US); Derek Silsby, Worcester, MA (US); Paul Carnes, North Dartmouth, MA (US)

(73) Assignee: Lowell Corporation, West Boylston, MA (US)

(21) Appl. No.: 13/462,169

(22) Filed: May 2, 2012

Related U.S. Application Data
(60) Provisional application No. 61/483,142, filed on May 6, 2011.

(51) Int. Cl. B25B 23/142

(52) U.S. Cl. 81/480

(57) ABSTRACT

A torque wrench assembly includes a handle, a socket housing coupled to the housing, and a socket rotatably coupled to the socket housing. The socket defines an opening extending along a longitudinal axis from a first end to a second end and having a fastener driving portion disposed at one of the first end and the second end of the socket.

### RELATED APPLICATIONS

This patent application claims the benefit of U.S. Patent Application No. 61/483,142 filed on May 6, 2011 entitled, “BOLT-THROUGH TORQUE WRENCH ASSEMBLY,” the contents and teachings of which are hereby incorporated by reference in their entirety.

### BACKGROUND

A conventional ratchet wrench is configured to tighten or loosen fasteners, such as nuts or bolts, with a series of sequential backward and forward rotations. For example, a typical ratchet wrench can include a ratchet head which is configured to engage a particularly sized fastener, such as a nut or a bolt head.

### SUMMARY

Conventional ratchet wrenches suffer from a variety of deficiencies. For example, conventional ratchet wrenches are configured to drive a corresponding socket attachment portion and socket carried by the wrench. The socket attachment portion is typically configured as a square or hex shaped male attachment portion having a ball detent. The male attachment portion is configured to couple to a corresponding socket receptacle of the socket. Using the attachment portion, a user can attach a variety of differently sized sockets (e.g., ⅜″, ¾″, ½″, etc.) relative to the wrench. With such a configuration, however, the conventional ratchet wrench is unable to provide bolt-though capabilities. Specifically, the socket attachment portion and socket blocks or prevents a bolt shaft from extending through the ratchet wrench.

By contrast to conventional ratchet wrenches, embodiments of the present invention relate to a bolt-through torque wrench assembly. In one arrangement, the bolt-through torque wrench assembly includes a handle having a socket housing that carries a bolt-through socket. The bolt-through socket is configured to allow a threaded shaft or similar structure to pass there through. With such a configuration, for example, the bolt-through torque wrench assembly can move a fastener along a length of the threaded shaft.

In one arrangement, a torque wrench assembly includes a handle, a socket housing coupled to the housing, and a socket rotatably coupled to the socket housing. The socket defines an opening extending along a longitudinal axis from a first end to a second end and having a fastener driving portion disposed at one of the first end and the second end of the socket.

In one arrangement, a torque wrench assembly includes a handle, a socket housing coupled to the handle, the socket housing defining a socket housing opening extending along a longitudinal axis of the socket housing between a first end and a second end, a socket disposed within the socket housing opening and rotatably coupled to the socket housing, the socket defining a socket opening extending along a longitudinal axis of the socket from a first end to a second end, the longitudinal axis of the socket being substantially collinear with the longitudinal axis of the socket housing, and the socket having a fastener driving portion disposed at one of the first end and the second end of the socket, and a ratchet mechanism disposed in operative communication with the socket, the ratchet mechanism configured to selectively provide one of clockwise ratcheting and counterclockwise ratcheting of the socket housing relative to the socket. The fastener driving portion includes a first fastener driving portion disposed at the first end of the socket, the first fastener driving portion configured to drive a fastener having a first size and a second fastener driving portion disposed at the second end of the socket, the second fastener driving portion configured to drive a fastener having a second size, the fastener having the second size being distinct from the fastener having the first size.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates a top view of a torque wrench assembly, according to one arrangement.

FIG. 2 illustrates a side and partial sectional view of the torque wrench assembly of FIG. 1, according to one arrangement.

FIG. 3 illustrates a top view of the handle of the torque wrench assembly of FIG. 1, according to one arrangement.

FIG. 4 illustrates a side view of the handle of the torque wrench assembly of FIG. 3, according to one arrangement.

FIG. 5 illustrates a top view of the handle of the torque wrench assembly of the torque wrench of FIG. 3 having a socket housing of the handle detached from a handle base, according to one arrangement.

FIG. 6 illustrates a side view of the handle of the torque wrench assembly of FIG. 5, according to one arrangement.

FIG. 7 illustrates a top view of a socket of the torque wrench assembly of FIG. 1, according to one arrangement.

FIG. 8 illustrates a side view of the socket of FIG. 7, according to one arrangement.

FIG. 9 illustrates a bottom view of the socket of FIG. 7, according to one arrangement.

FIG. 10 illustrates a top view of a socket housing assembly of FIG. 1, according to one arrangement.

FIG. 11 illustrates a side and partial sectional view of the socket housing assembly of FIG. 10, according to one arrangement.

FIG. 12 illustrates a perspective sectional view of the socket of FIG. 1, according to one arrangement.

FIG. 13 illustrates a perspective sectional view of a socket of FIG. 1, according to one arrangement.

### DETAILED DESCRIPTION

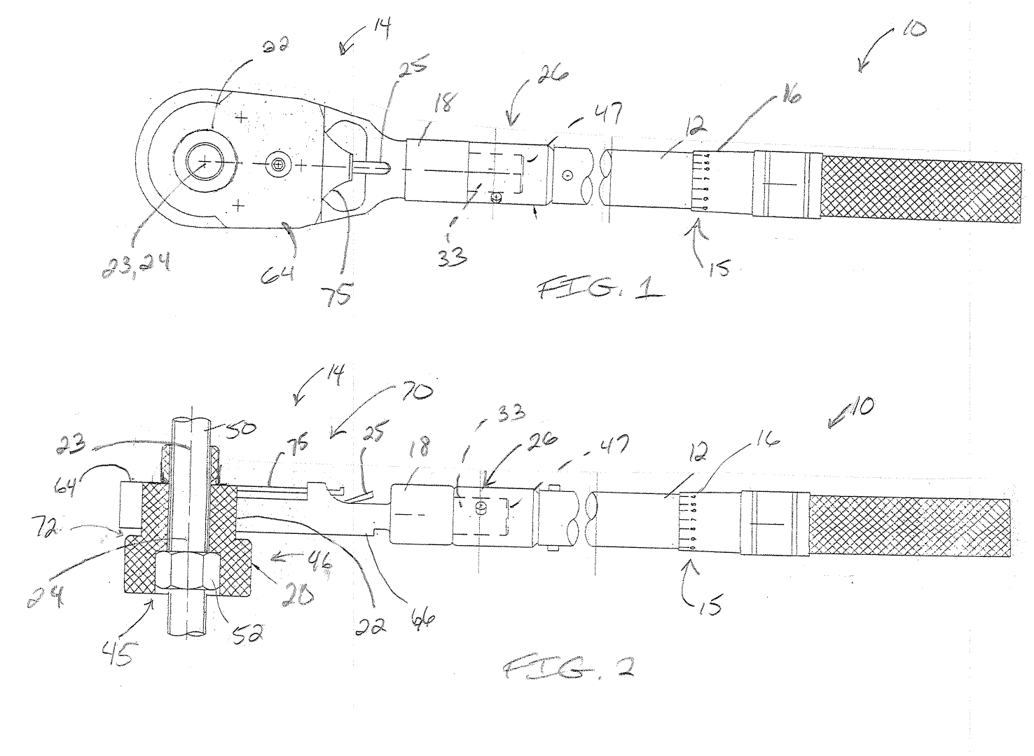

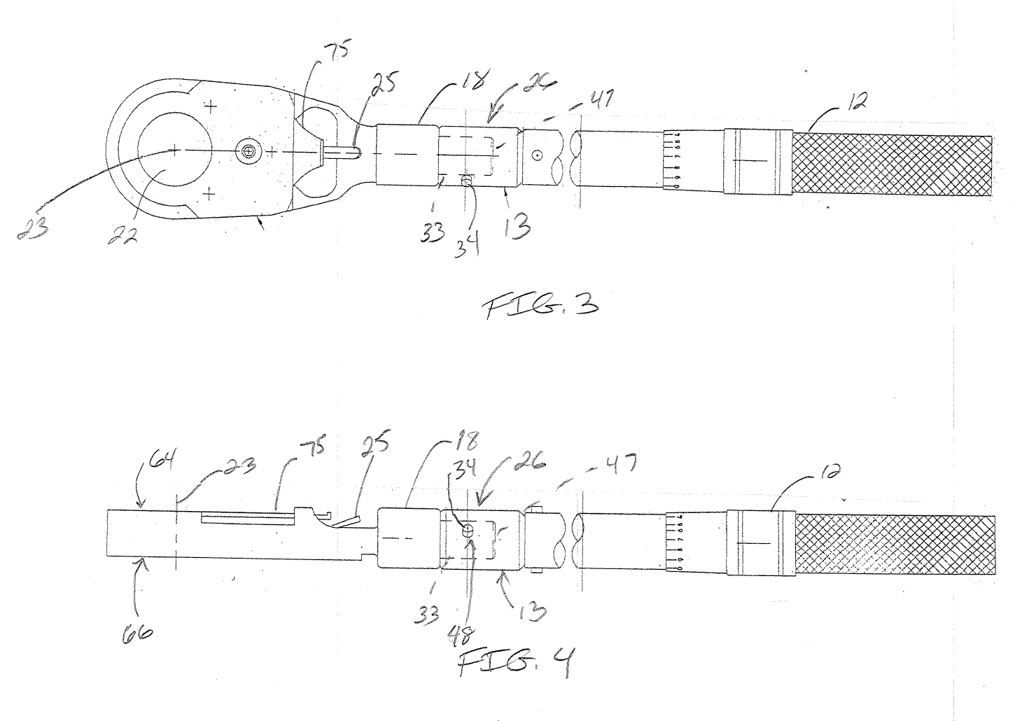

FIGS. 1 and 2 illustrate a torque wrench assembly 10, such as used in the water works industry, according to one arrangement. The torque wrench assembly 10 includes a handle 12 and a socket housing assembly 14 coupled to the handle 12. As illustrated, the socket housing assembly 14 includes a socket housing 18 that carries a socket 20. As will be described in detail below, the socket housing assembly 14 provides bolt-through torquing capabilities to the torque wrench assembly 10.

The handle 12 is configured to support the socket housing assembly 14 and to provide torque wrench assembly 10 with the ability to generate adequate torque on a fastener 52, such as a nut, to rotate the fastener 52 in either a clockwise or counterclockwise direction relative to elongate structure 50, such as a threaded shaft or bolt. For example, the handle 12 can have a length between about 17 inches and 22 inches to provide the torque wrench assembly 10 with the ability to generate sufficient torque on the fastener 52 to rotate the fastener 52 relative to the elongate structure 50.

In one arrangement, the handle 12 includes a torque limitation mechanism 15 configured to detect a torque applied to the fastener 52 by the torque wrench assembly 10. In response to detecting the torque as reaching a preset torque amount, the torque limitation mechanism 15 is configured to provide a notification, such as a torque application signal, to a user. While the torque limitation mechanism 15 can be configured in a variety of ways, in one arrangement, the torque limitation mechanism 15 is configured as a click type mechanism. For example, the torque limitation mechanism 15 can include an adjustable spring mechanism as well as a ball and ball detent mechanism. A user can preset a target torque amount on the spring mechanism by adjusting the spring tension using a screw thread 16. For example, the screw thread 16 can adjust the tension on the spring mechanism within a range from between about 20 ft-lbs. to 150 ft-lbs. in increments of one foot-pound (ft-lb.). The spring mechanism, in turn generates a force against the ball.

During operation, as the torque wrench assembly 10 applies torque to the fastener 52, the spring generates a force on the ball to maintain the ball within the ball detent. Once the torque wrench assembly 10 reaches the preset torque amount, the ball overcomes the force exerted on it by the spring, exits the detent, and strikes the housing or other part of the wrench to produce an audible clicking (i.e., a torque application signal). The clicking notifies the user that the torque wrench assembly 10 has reached the preset torque amount.

As indicated above, the socket housing assembly 14 includes a socket housing 18 that carries socket 20 and provides bolt-through torquing capabilities to the torque wrench assembly 10. In such an arrangement, with reference to FIGS. 3 through 5, the socket housing 18 defines a socket housing opening 22 that extends along a longitudinal axis 23 of the socket housing 18 between a first end or face 64 and a second end or face 66 of the socket housing 18. As will be described in detail below, the socket housing 18 carries the socket 20 in the socket housing opening 22 such that the longitudinal axis 23 of the socket housing opening 22 is substantially collinear with a longitudinal axis of an opening defined by the socket 20.

In one arrangement, the socket housing 18 includes a ratchet mechanism (not shown) disposed in operative communication with the socket 20. The ratchet mechanism is configured to selectively provide one of clockwise ratcheting and counterclockwise ratcheting of the socket housing 18 relative to the socket 20 during operation. For example, the ratchet mechanism can include a lever or switch 25 that allows the user to toggle the driving direction of the socket 20 between a clockwise driving direction and a counter clockwise driving direction so that the fastener 52 can be tightened or loosened relative to member 50.

In use, when the lever 25 is disposed in a first position, a pawl associated with the ratchet mechanism interacts with teeth associated with the socket 20 such that clockwise rotation of handle 12 causes the pawl to engage one or more of the teeth and causes the socket 20 to rotate with the socket housing 18 to tighten a corresponding fastener 52. Additionally, when the lever 25 is disposed in the first position, as a user rotates the handle 12 in a counterclockwise direction the socket 20 remains substantially stationary relative to the socket housing 18. When the lever 25 is disposed in a second position, the pawl associated with the ratchet mechanism interacts with teeth associated with the socket 20 such that counterclockwise rotation of handle 12 causes the pawl to engage one or more of the teeth and causes the socket 20 to rotate with the socket housing 18 to loosen the corresponding fastener 52. Additionally, when the lever 25 is disposed in the second position, as the user rotates the handle 12 in a clockwise direction the socket 20 remains substantially stationary relative to the socket housing 18.

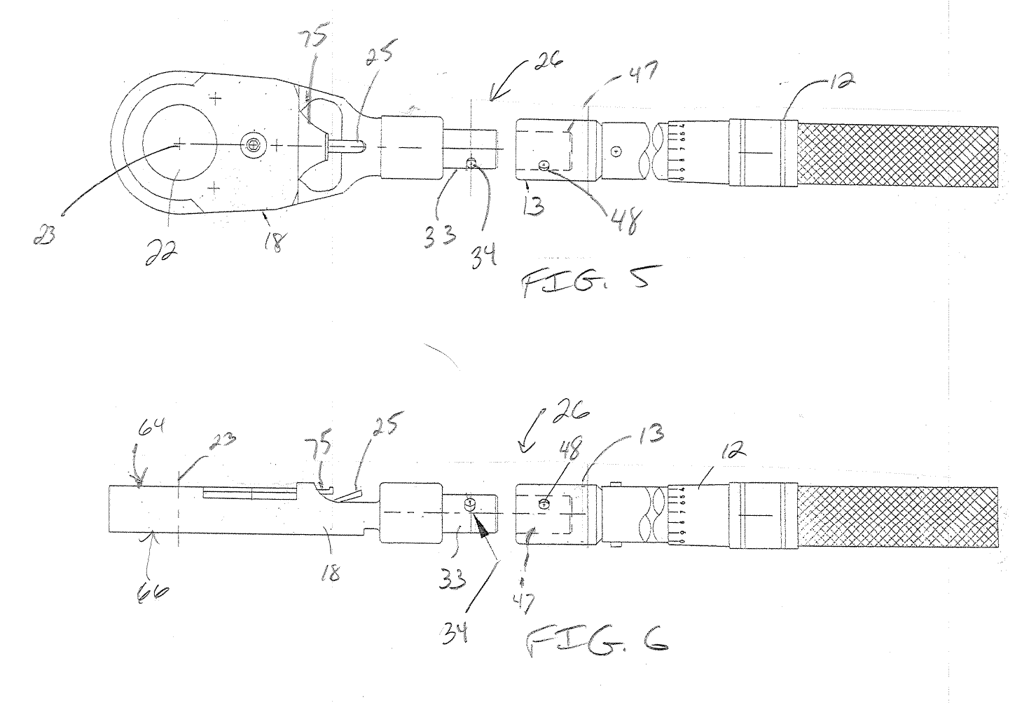

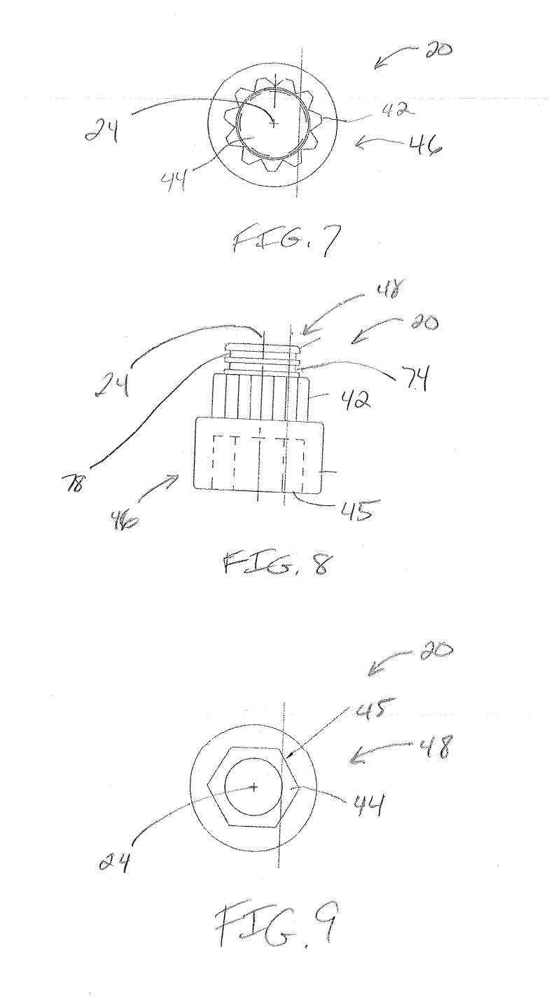

With continued reference to FIGS. 1 through 6, in one arrangement, the socket housing 18 is configured as being detachably coupled to the handle 12. Such a configuration allows a user to replace the socket housing 18 with housings 18 carrying differently sized sockets 20, depending upon the size of a corresponding fastener 52 to be actuated. For example, the socket housing 18 includes a coupling mechanism 26 moveable between a first position, as shown in FIGS. 3 and 4, that secures the socket housing 18 to the handle 12 and a second position, as shown in FIGS. 5 and 6, that releases the socket housing 18 from the handle 12.

While the coupling mechanism 26 can be configured in a variety of ways, in one arrangement, the socket housing 18 defines a proximal extending portion 33 that inserts within a cavity 47 at a distal end 13 of the handle 12. A spring pin 34 engages a corresponding opening 48 defined by the distal end 13 of the handle 12 to releasably couple the socket housing 18 to the handle 12. For example, with reference to FIGS. 3 and 4, the spring pin 34 is disposed within the opening 48 of the handle 12 to secure the housing 18 to the handle 12. A user can depress the spring pin 34 toward a longitudinal axis of the handle 12 to disengage the spring pin 34 from the opening 48 to allow the user to remove the socket housing 18 from the handle 12.

As indicated above, the socket housing 18 carries the socket 20 in the socket housing opening 22. In order to provide bolt-through torquing capabilities to the torque wrench assembly 10, the socket 20 is configured as a bolt-through socket. For example, with reference to FIGS. 7 through 9, the socket 20 is configured as a generally cylindrical structure defining an opening 44 extending along the longitudinal axis 24 from a first end 46 to a second end 48, there through. When secured to the socket housing 18, the longitudinal axis 24 of the opening 44 defined by the socket 20 is substantially collinear with the longitudinal axis 23 of the socket housing opening 22 of the socket housing 18, as indicated in FIGS. 1 and 2.

With such a configuration, a user can utilize the bolt-through socket 20 to move the fastener 52, such as a nut, along a threaded shaft where the shaft extends through the opening 44 of the socket 20. For example, with reference to FIG. 2, the socket 20 and socket housing 18 can be disposed about an elongate structure 50, such as a threaded shaft or bolt, with the elongate structure 50 extending through the opening 44. The socket 20, accordingly, provides an associated fastener driving portion 45 with access to a fastener 52 disposed at a far end of the structure 50.

Returning to FIGS. 7 through 9 the socket 45 includes a fastener driving portion 45 disposed at the first end 46 of the socket 20. The fastener driving portion 45 is configured to interface with and actuate a particularly-sized fastener 52. For example, the fastener driving portion 45 can be configured to actuate a fastener 52 having a size of 1.25 (1¼) Hex.

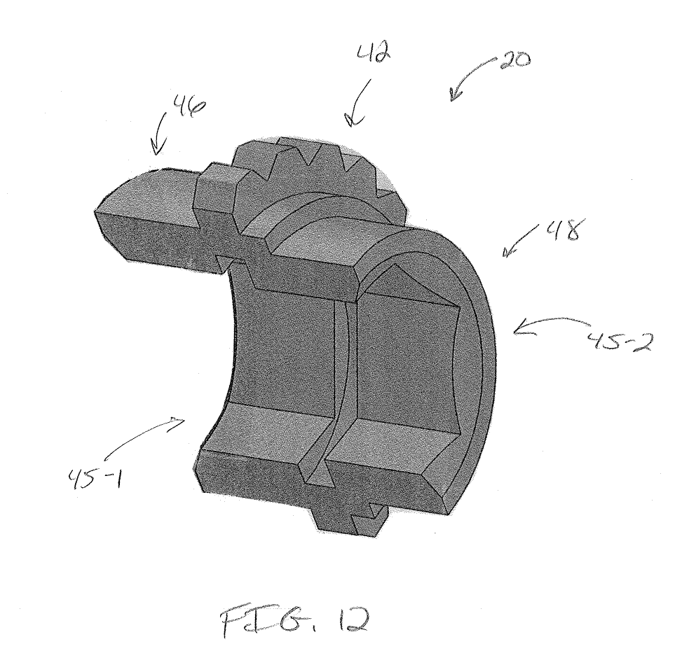

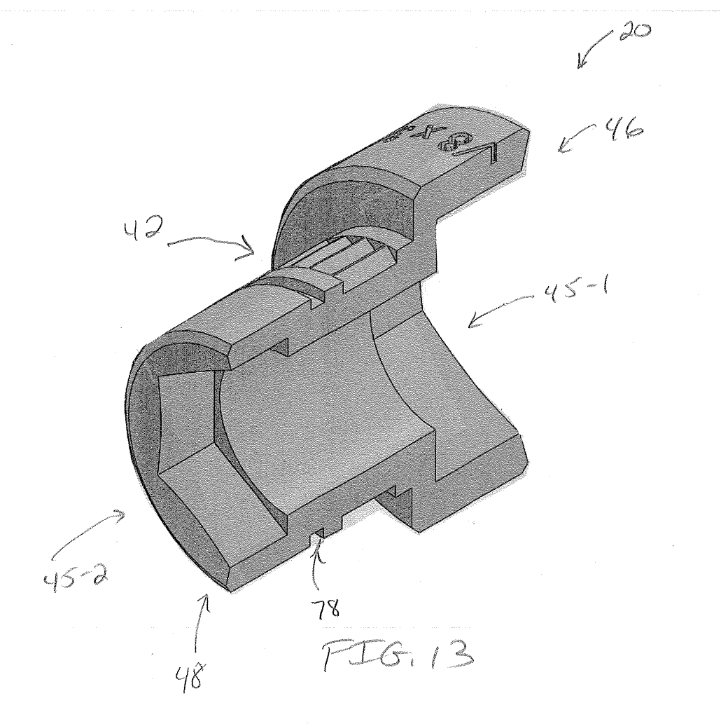

While FIGS. 7 through 9 illustrate the socket 20 as having a single fastener driving portion 45, such illustration is by way of example only. In one arrangement, with reference to FIG. 12, the socket 20 includes opposing fastener driving portions 45 disposed within an inner periphery of the socket 20 at opposing ends 46, 48 of the socket 20. For example, the socket 20 includes a first fastener driving portion 45-1 disposed at a first end 46 and a second fastener driving portion 45-2 disposed at a second end 48. While the fastener driving portions 45 can be configured in a variety of ways, in one arrangement, the fastener driving portions 45 are configured as hex drive structures having six point hexes or twelve point hexes, for example. In another arrangement, fastener driving portions 45 are configured as square drive or star-shaped openings that accept more than one fastener size.

The fastener driving portions 45 of the socket 20 are configured to actuate two differently-sized fasteners 52. For example, the fastener driving portion 45-1 can be configured to drive a fastener 52, such as nut or bolt head, having a first size, such as a size of 1.25 (1¼) Hex. The fastener driving portion 45-2 can be configured to drive a fastener 52, such as nut or bolt head, and having a second size, such as a size of 1.125 (1⅛) Hex. Accordingly, the torque wrench assembly 10 provides a two-in-one fastener driving capability.

As indicated above, the socket 20 includes a set of teeth 42 disposed about an outer periphery of the cylinder structure and configured to mesh with the ratchet mechanism. While the teeth 42 can be configured in a variety of ways, in the arrangement illustrated in FIG. 12, the teeth 42 are configured as external teeth (i.e., as a gear) where the outer tooth diameter of each of the teeth is greater than either of the outside diameters of either end 46, 48 of the socket 20. In another arrangement, as illustrated in FIG. 13, the teeth 42 are configured as internal teeth as part of the socket 20 where the outer tooth diameter of each of the teeth is less than or equal to the outside diameters of both ends 46, 48 of the socket 20. As illustrated in FIG. 13, the outer diameter of the teeth 42 is equal to one outside end diameter, allowing for the socket 20 to be inserted into an opening extending through the socket housing 18 allowing for the teeth 42 of the socket 20 to pass through the socket housing opening, thereby providing ease of assembly. Additionally, while the set of teeth 42 can include any number of teeth, in one arrangement, the set of teeth 42 include between about 20 teeth and 50 teeth to minimize backlash with the ratchet mechanism.

Returning to FIGS. 1 and 2, the socket 20 is disposed within the socket housing opening 22 and is rotatably coupled or secured to the socket housing 18. The socket 20 can be secured to the socket housing 18 in a variety of ways. For example, the geometry of the socket 20 in conjunction with a fastener 70, such as a lever 75, provides rotatable attachment of the socket 20 to the socket housing 18.

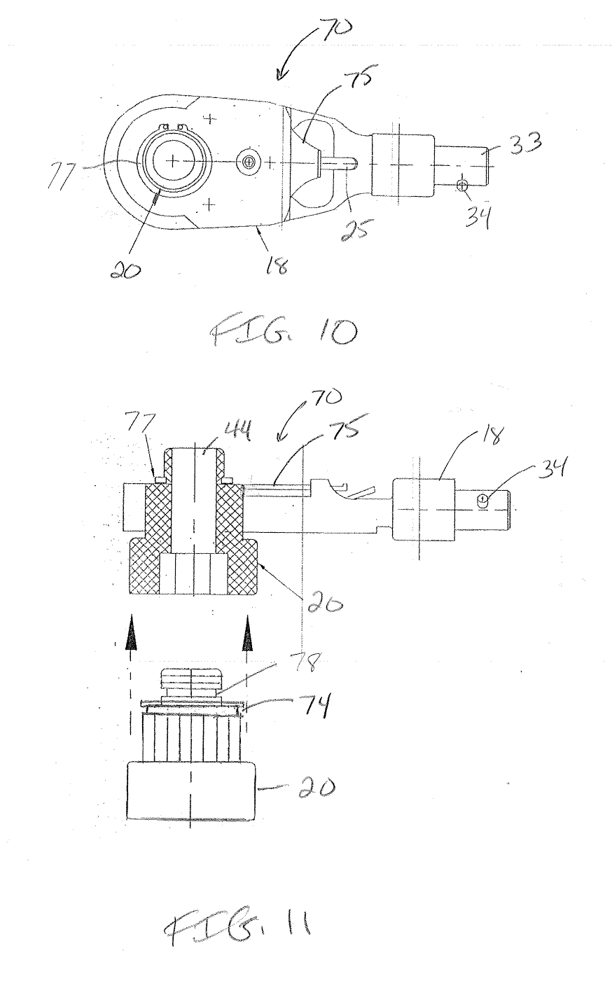

For example, with continued reference to FIGS. 1 and 2, the first end 46 of the socket 20 defines a shoulder portion 72 that extends about a circumference of the socket 20. The second end 48 of the socket 20 defines a groove portion 74, as shown in FIG. 8, which extends about the circumference of the socket 20. With reference to FIG. 2, when the socket 20 is disposed within the socket housing opening 22 of the socket housing 18, the shoulder portion 72 of the socket 20 is disposed in proximity to the second face 66 of the socket housing 18 and the groove portion 74 of the socket 20 is disposed in proximity to the first face 64 of the socket housing 20. The lever 75 inserts within part of the groove portion 74 of the socket 20 such that the lever 75 and the shoulder portion 72 of the socket 20 captures the socket housing 18 there between. The f lever 75 secures the socket 20 to the socket housing 18 and allows the socket 20 to rotate relative to the socket housing 18 and about the longitudinal axis 24.

In one arrangement, the fastener 70 further includes a snap ring 77, as illustrated in FIGS. 10 and 11 configured to engage a second groove portion 78 that extends about the circumference of the socket 20. With reference to FIG. 2, when the socket 20 is disposed within the socket housing opening 22 of the socket housing 18, the second groove portion 78 of the socket 20 is disposed in proximity to the first face 64 of the socket housing 20. The snap ring 77 is disposed within part of the second groove portion 78 to secure the socket 20 to the socket housing 18 while allowing rotation of the socket 20 relative to the socket housing 18 during use.

FIGS. 10 and 11 illustrate the fastener 70 as including both the lever 75 and the snap ring 77. Such illustration is by way of example only. In one arrangement, the snap ring 77 operates as the sole fastener 70 to rotatably secure the socket 20 to the socket housing 18.

During operation, with continued reference to FIG. 2, a user can dispose an elongate structure 50, such as a threaded shaft or bolt, within the opening 44 defined by the socket 20. The user can then position the torque wrench assembly 10 along direction 90 until the fastener driving portion 45 engages the fastener 52. The user can then rotate the handle 12 in either in a clockwise or counterclockwise to position the fastener 52 relative to the elongate structure 50.

As indicated above, the fastener 70 rotatably secures the socket 20 to the socket housing 18 and the socket housing 18 is detachable from the handle 12 to allow a user to replace the socket housing 18 with housings 18 having differently sized sockets 20, depending upon the size of a corresponding fastener 52 to be actuated. In one arrangement, the fastener 70 is further configured to allow a user to remove the socket 20 from the torque wrench assembly 10 and replace it with a socket 20 having a differently sized fastener driving portion 45.

For example, the lever 75 is moveable between a first position relative to the groove portion 74, as shown in FIGS. 1 and 2, to secure the socket 20 to the socket housing 18 and a second position relative to the groove portion 74 (not shown) to release the socket 20 from the socket housing 18. Once released, a user can remove the socket 20 from the torque wrench assembly 10

In another arrangement, the snap ring 77 is formed of a relatively flexible material to allow the user to readily remove and attach the snap ring 77 relative to a socket 20. In such an arrangement, a user can deform the flexible snap ring 77 manually to remove the snap ring 77 from the groove portion 74 of the socket 20, remove the socket 20 from the socket housing 18 and install a socket 20 with a differently sized fastener driving portion 45 in its place.

While various embodiments of the invention have been particularly shown and described, it will be understood by those skilled in the art that various changes in form and details may be made therein without departing from the spirit and scope of the invention as defined by the appended claims.

For example, as described above, the fastener driving portions 45-1, 45-2 can be sized to 1¼ Hex and 1⅛ Hex, respectively. Such description is by way of example only. In one arrangement, the fastener driving portions 45-1, 45-2 can be configured with a variety of sizes. For example, the fastener driving portions 45-1, 45-2 can be sized to and 1 1/16 Hex and 15/16 Hex, to ¾″Hex and ⅞″Hex, and to 15/16″ Hex and 1 1/16″ Hex, respectively. In another arrangement, the fastener driving portions 45-1, 45-2 can be sized to 17 mm Hex and 19 mm Hex and to 22 mm Hex and 24 mm Hex, respectively.

What is claimed is:

1. A torque wrench assembly, comprising:
a handle;
a socket housing coupled to the handle, the socket housing defining a socket housing opening extending along a longitudinal axis of the socket housing between a first end and a second end; and
a socket disposed within the socket housing opening and rotatably coupled to the socket housing, the socket defining a socket opening extending along a longitudinal axis of the socket from a first end to a second end, the longitudinal axis of the socket being substantially collinear with the longitudinal axis of the socket housing, and the socket having a fastener driving portion disposed at one of the first end and the second end of the socket.

2. The torque wrench assembly of claim 1, wherein the socket housing comprises a ratchet mechanism disposed in operative communication with the socket, the ratchet mechanism configured to selectively provide one of clockwise ratcheting and counterclockwise ratcheting of the socket housing relative to the socket.

3. The torque wrench assembly of claim 2, wherein the socket comprises a set of teeth configured to mesh with the ratchet mechanism, the set of teeth configured as external teeth wherein a root diameter of the external teeth is greater than a diameter of the first end and the second end of the socket.

4. The torque wrench assembly of claim 2, wherein the socket comprises a set of teeth configured to mesh with the ratchet mechanism, the set of teeth configured as internal teeth wherein a root diameter of the internal teeth is less than or equal to a diameter of the socket.

5. The torque wrench assembly of claim 1, wherein the socket housing is removeably coupled to the handle, the socket housing comprising a coupling mechanism moveable between a first position that secures the socket housing to the handle and a second position that releases the socket housing from the handle.

6. The torque wrench assembly of claim 1, wherein the socket is removeably coupled to the socket housing.

7. The torque wrench assembly of claim 6, wherein:
the first end of the socket defines a shoulder portion extending at least partially about a circumference of the socket, the shoulder portion disposed in proximity to a first face of the socket housing; and
the second end of the socket defines a groove portion extending at least partially about a circumference of the socket the groove portion disposed in proximity to a second face of the socket housing;
wherein the socket housing comprises a fastener configured to couple with the groove portion of the socket, the shoulder portion of the socket and the fastener configured to capture the socket housing there between.

8. The torque wrench assembly of claim 7, wherein the fastener is configured as a lever moveable between a first position relative to the groove portion to secure the socket to the socket housing and a second position relative to the groove portion to release the socket from the socket housing.

9. The torque wrench assembly of claim 7, wherein the fastener is configured as a snap ring.

10. The torque wrench assembly of claim 1, wherein the fastener driving portion comprises:
a first fastener driving portion disposed at the first end of the socket, the first fastener driving portion configured to drive a fastener having a first size; and
a second fastener driving portion disposed at the second end of the socket, the second fastener driving portion configured to drive a fastener having a second size, the fastener having the second size being distinct from the fastener having the first size.

11. The torque wrench assembly of claim 1, further comprising a torque limitation mechanism configured to detect a torque applied to a fastener by the torque wrench assembly and generate a torque application signal when the torque applied to the fastener reaches a preset torque amount.

12. A torque wrench assembly, comprising:
a handle;
a socket housing coupled to the handle, the socket housing defining a socket housing opening extending along a longitudinal axis of the socket housing between a first end and a second end;
a socket disposed within the socket housing opening and rotatably coupled to the socket housing, the socket defining a socket opening extending along a longitudinal axis of the socket from a first end to a second end, the longitudinal axis of the socket being substantially collinear with the longitudinal axis of the socket housing, and the socket having a fastener driving portion disposed at one of the first end and the second end of the socket; and
a ratchet mechanism disposed in operative communication with the socket, the ratchet mechanism configured to selectively provide one of clockwise ratcheting and counterclockwise ratcheting of the socket housing relative to the socket;
wherein the fastener driving portion comprises:
a first fastener driving portion disposed at the first end of the socket, the first fastener driving portion configured to drive a fastener having a first size; and
a second fastener driving portion disposed at the second end of the socket, the second fastener driving portion configured to drive a fastener having a second size, the fastener having the second size being distinct from the fastener having the first size.

13. The torque wrench assembly of claim 12, wherein the socket comprises a set of teeth configured to mesh with the ratchet mechanism, the set of teeth configured as external teeth wherein a root diameter of the external teeth is greater than a diameter of the first end and the second end of the socket.

14. The torque wrench assembly of claim 12, wherein the socket comprises a set of teeth configured to mesh with the ratchet mechanism, the set of teeth configured as internal teeth wherein a root diameter of the internal teeth is less than or equal to a diameter of the socket.

15. The torque wrench assembly of claim 12, wherein the socket housing is removeably coupled to the handle, the socket housing comprising a coupling mechanism moveable between a first position that secures the socket housing to the handle and a second position that releases the socket housing from the handle.

16. The torque wrench assembly of claim 12, wherein the socket is removeably coupled to the socket housing.

17. The torque wrench assembly of claim 16, wherein:
the first end of the socket defines a shoulder portion extending at least partially about a circumference of the socket, the shoulder portion disposed in proximity to a first face of the socket housing; and
the second end of the socket defines a groove portion extending at least partially about a circumference of the socket the groove portion disposed in proximity to a second face of the socket housing;
wherein the socket housing comprises a fastener configured to couple with the groove portion of the socket, the shoulder portion of the socket and the fastener configured to capture the socket housing there between.

18. The torque wrench assembly of claim 17, wherein the fastener is configured as a lever moveable between a first position relative to the groove portion to secure the socket to the socket housing and a second position relative to the groove portion to release the socket from the socket housing.

19. The torque wrench assembly of claim 17, wherein the fastener is configured as a snap ring.

20. The torque wrench assembly of claim 12, further comprising a torque limitation mechanism configured to detect a torque applied to a fastener by the torque wrench assembly and generate a torque application signal when the torque applied to the fastener reaches a preset torque amount.
